(19) United States
(12) Patent Application Publication
(10) Pub. No.: US 2003/0157276 A1
(43) Pub. Date: Aug. 21, 2003

(54) Ink recording element

(75) Inventor: Charles E. Romano JR., Rochester, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/068,824

(22) Filed: Feb. 6, 2002

(51) Int. Cl. B32B 3/00

(52) U.S. Cl. 428/32.1; 428/32.28

(57) ABSTRACT

The present invention comprises an ink recording element comprising a support having thereon a hydrophilic absorbing layer and a laminate adhesion promoting absorbing hydrophilic overcoat. The hydrophilic absorbing layer preferably comprises a natural or synthetic polymer, preferably gelatin. The laminate adhesion promoting absorbing hydrophilic overcoat polymer preferably comprises a mixture of acetoacetylated poly (vinyl alcohol) and polyurethane dispersion or latex polymer. In another embodiment, an ink printing method comprising providing an ink recording element as described above; and applying liquid ink droplets thereon in an image-wise manner is disclosed.

### CROSS REFERENCE TO RELATED APPLICATIONS

Reference is made to commonly assigned, co-pending U.S. patent application Nos.:

Ser. No. ______ by Charles E. Romano, Jr. et al. (Docket 82840) filed of even date herewith entitled “Ink Recording Element Having Adhesion Promoting Material”;

Ser. No. ______ by Charles E. Romano, Jr. et al (Docket 83885) filed of even date herewith entitled “Ink Recording Element Containing A Laminate Adhesion Promoting Inner Layer”; and

Ser. No. ______ by Charles E. Romano, Jr. et al. (Docket 83161) filed of even date herewith entitled “Ink Recording Element”, the disclosures of which are incorporated herein.

### FIELD OF THE INVENTION

The present invention relates to an ink image-recording element.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water, an organic material such as a monohydric alcohol, a polyhydric alcohol or mixtures thereof.

An ink recording element typically comprises a support having on at least one surface thereof an ink-receiving or image-forming layer, and includes those intended for reflection viewing, which have an opaque support, and those intended for viewing by transmitted light, which have a transparent support.

In order to achieve and maintain high quality images on such an image-recording element, the recording element must:

Exhibit no banding, bleed, coalescence, or cracking in inked areas.

Exhibit the ability to absorb large amounts of ink and dry quickly to avoid blocking.

Exhibit high optical densities in the printed areas.

Exhibit freedom from differential gloss.

Have high levels of image fastness to avoid fade from contact with water or radiation by daylight, tungsten light, or fluorescent light.

Have excellent adhesive strength so that delamination does not occur.

While a wide variety of different types of image recording elements for use with ink printing are known, there are many unsolved problems in the art and many deficiencies in the known products, which have severely limited their commercial usefulness. A major challenge in the design of an image-recording element is laminate adhesion. A typical coating from the prior art comprises a layer containing hydroxypropylmethyl cellulose, hydroxyethyl cellulose and a vinyl latex polymer, a layer of pectin, a layer of poly(vinyl alcohol) and polyurethane, and a layer of lime processed osseine gelatin in the order recited. This formulation has demonstrated poor laminate adhesion. U.S. Pat. No. 6,280,027 discloses a single layer inkjet recording element which has a base layer polymer, comprised of a blend of anionic, water dispersible polyurethane and a hydrophilic polymer. This inkjet recording element, as disclosed, demonstrates inadequate laminate adhesion in only a single layer format. U.S. Pat. Nos. 5,942,335 and 5,856,023 disclose an ink receiving layer which is a mixture of derivatized and underivatized poly(vinyl alcohol). The layer may also contain poly(vinylbenzyl quaternary ammonium salt) with or without polyvinylpyrrolidinone. U.S. Pat. Nos. 6,010,790 and 6,068,373 disclose an ink receiving layer comprising a hydrophilic polymer, preferably poly(vinyl alcohol), and a contain poly(vinylbenzyl quaternary ammonium salt). The composition may optionally contain derivatized and underivatized poly(vinyl alcohol). Acetoacetylated poly(vinyl alcohol) is disclosed as a single ink receiving layer in U.S. Pat. Nos. 6,020,398, 6,074,057, 6,137,514, 6,161,929, 6,206,517, 6,224,202, and 6,276,791. U.S. Pat. No. 6,224,971 discloses acetoacetylated poly(vinyl alcohol) in combination with polyvinylpyrrolidinone resin and an acidic aqueous dispersion of colloidal silica.

It is an object of this invention to provide a multilayer ink recording element which has excellent image quality, and better laminate adhesion than the elements of the prior art.

### SUMMARY OF THE INVENTION

The present invention comprises an ink recording element comprising a support having a hydrophilic absorbing layer and a laminate adhesion promoting absorbing hydrophilic overcoat polymer layer.

The present invention has several advantages. Primarily, the ink recording element of the invention produces an image which has excellent image quality, and better laminate adhesion than the elements of the prior art. The elements made according to the present invention also may exhibit no banding, bleed, coalescence, or cracking in inked areas. They have the ability to absorb large amounts of ink and dry quickly to avoid blocking and exhibit high optical densities in the printed areas. Freedom from differential gloss and high levels of image fastness to avoid fade from contact with water or radiation by daylight, tungsten light, or fluorescent light are additional advantages.

### DETAILED DESCRIPTION OF THE INVENTION

The present invention comprises an ink recording element comprising a support having thereon a hydrophilic absorbing layer comprising a natural or synthetic polymer, preferably gelatin, and a laminate adhesion promoting absorbing hydrophilic overcoat polymer, preferably comprising a mixture of acetoacetylated poly (vinyl alcohol) and latex polymer.

Another embodiment of the invention relates to an ink printing method comprising providing an ink recording element as described above, and applying liquid ink droplets thereon in an image-wise manner.

In accordance with the invention, it has been found that a specific combination of image receiving layers, each comprised of specific materials and arranged in a specific sequence on a support material, yields excellent ink imaging performance for a wide range of commercially available printing systems.

As noted above, the hydrophilic absorbing layer comprises a natural or synthetic polymer. Preferred is a hydrophilic absorbing layer comprising gelatin or poly (vinyl alcohol) (PVA). This layer may also contain other hydrophilic materials such as naturally-occurring hydrophilic colloids and gums such as albumin, guar, xantham, acacia, chitosan, starches and their derivatives, functionalized proteins, functionalized gums and starches, and cellulose ethers and their derivatives, polyvinyloxazoline, such as poly(2-ethyl-2-oxazoline) (PEOX), polyvinylmethyloxazoline, polyoxides, polyethers, poly(ethylene imine), poly(acrylic acid), poly(methacrylic acid), n-vinyl amides including polyacrylamide and polyvinylpyrrolidinone (PVP), and poly(vinyl alcohol) derivatives and copolymers, such as copolymers of poly(ethylene oxide) and poly(vinyl alcohol) (PEO-PVA). The gelatin used in the present invention may be made from animal collagen, but gelatin made from pig skin, cow skin, or cow bone collagen is preferable due to ready availability. The kind of gelatin is not specifically limited, but lime-processed gelatin, acid processed gelatin, amino group inactivating gelatin (such as acetylated gelatin, phthaloylated gelatin, malenoylated gelatin, benzoylated gelatin, succinylated gelatin, methyl urea gelatin, phenylcarbamoylated gelatin, and carboxy modified gelatin), or gelatin derivatives (for example, gelatin derivatives disclosed in JP Patent publications 38-4854/1962, 39-5514.1964, 40-12237/1965, 42-26345/1967 and 2-13595/1990, U.S. Pat. Nos. 2,525,753, 2,594,293, 2,614,928, 2,763,639, 3,118,766, 3,132,945, 3,186,846, 3,312,553 and GB Patents 861,414 and 103,189) can be used singly or in combination. Most preferred are pigskin or modified pigskin gelatins and acid processed osseine gelatins due to their effectiveness for use in the present invention.

The hydrophilic absorbing layer must effectively absorb both the water and humectants commonly found in printing inks. In a preferred embodiment of the invention, two hydrophilic absorbing layers are present, one comprising gelatin, and the other comprising hydrophilic materials such as naturally-occurring hydrophilic colloids and gums such as albumin, guar, xantham, acacia, chitosan, starches and their derivatives, functionalized proteins, functionalized gums and starches, and cellulose ethers and their derivatives, polyvinyloxazoline, such as poly(2-ethyl-2-oxazoline) (PEOX), non-modified gelatins, polyvinylmethyloxazoline, polyoxides, polyethers, poly(ethylene imine), n-vinyl amides including polyacrylamide and polyvinylpyrrolidinone (PVP), and poly(vinyl alcohol) derivatives and copolymers, such as copolymers of poly(ethylene oxide) and poly(vinyl alcohol) (PEO-PVA), polyurethanes, and polymer latices such as polyesters and acrylates. In another preferred embodiment of the invention, the hydrophilic absorbing layers comprise a base layer comprising gelatin and at least one upper layer, also referred to as an inner layer, located between the hydrophilic absorbing gelatin layer, and the absorbing hydrophilic overcoat polymer layer. These embodiments provide enhanced image quality. The inner layer typically comprises a mixture of poly(vinyl alcohol) and a polyurethane dispersion, such as Witcobond® 232, in a ratio of about 50:50 to about 95:5 PVA to polyurethane. The hydrophilic materials employed in the second hydrophilic absorbing layer or inner layer may be present in any amount which is effective for the intended purpose. In general, the dry layer thickness of the gelatin layer is from about 5 to 60 microns, below which the layer is too thin to be effective and above which no additional gain in performance is noted with increased thickness. The dry layer thickness of the poly(vinyl alcohol)/Witcobond® 232 inner layer is from about 0.5 to 5 microns.

The laminate adhesion promoting absorbing hydrophilic overcoat comprises a modified poly(vinyl alcohol) (PVA). Preferred is a derivatized poly(vinyl alcohol) having at least one hydroxyl group replaced by ether or ester groupings. Especially preferred is an acetoacetylated poly(vinyl alcohol) in which the hydroxyl groups are esterified with acetoacetic acid having an average molecular weight of from about 15,000 to 150,000, a saponification degree (mol %) of from about 80-100%, and a modification degree (mol %) of from about 2.5-15%. These PVA compounds are readily available and effective with the present invention. This layer may also contain polyurethanes or vinyl latex polymers and other hydrophilic materials such as cellulose derivatives, e.g., cellulose ethers like methyl cellulose (MC), ethyl cellulose, hydroxypropyl cellulose (HPC), sodium carboxymethyl cellulose (CMC), calcium carboxymethyl cellulose, methylethyl cellulose, methylhydroxyethyl cellulose, hydroxypropylmethyl cellulose (HPMC), hydroxybutylmethyl cellulose, ethylhydroxyethyl cellulose, sodium carboxymethyl-hydroxyethyl cellulose, and carboxymethylethyl cellulose, and cellulose ether esters such as hydroxypropylmethyl cellulose phthalate, hydroxypropylmethyl cellulose acetate succinate, hydroxypropyl cellulose acetate, esters of hydroxyethyl cellulose and diallyldimethyl ammonium chloride, esters of hydroxyethyl cellulose and 2-hydroxypropyltrimethylammonium chloride and esters of hydroxyethyl cellulose and a lauryldimethylammonium substituted epoxide (HEC-LDME), such as Quatrisoft® LM200 (Amerchol Corp.) as well as hydroxyethyl cellulose grafted with alkyl C₁₂-C₁₄ chains, naturally-occurring hydrophilic colloids and gums such as albumin, guar, xantham, acacia, chitosan, starches and their derivatives, functionalized proteins, functionalized gums and starches, and cellulose ethers and their derivatives, polyvinyloxazoline, such as poly(2-ethyl-2-oxazoline) (PEOX), modified or non-modified bone or pigskin gelatins, polyvinylmethyloxazoline, polyoxides, polyethers, poly(ethylene imine), n-vinyl amides including polyacrylamide and polyvinylpyrrolidinone (PVP), and poly(vinyl alcohol) derivatives and copolymers, such as copolymers of poly(ethylene oxide) and poly(vinyl alcohol) (PEO-PVA).

In a preferred embodiment of the invention, the laminate adhesion promoting absorbing hydrophilic overcoat layer comprises a mixture of acetoacetylated poly(vinyl alcohol) and polyurethane dispersion in a weight ratio from about 50:50 to 95:5. Outside of this weight ratio, incompatibility may occur. The preferred dry coverage of the overcoat layer is from about 0.5 to 5 microns as is common in practice.

The polyurethanes utilized in the present invention preferably comprise anionic, water-dispersible polyurethane polymers having the following general formula:

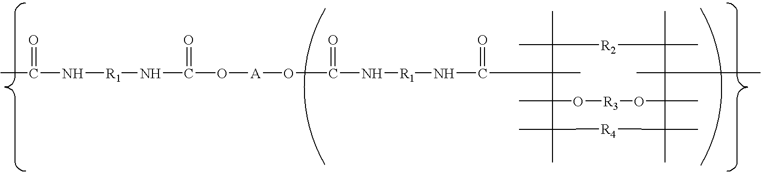

wherein:

R₁ is represented by one or more of the following structures:

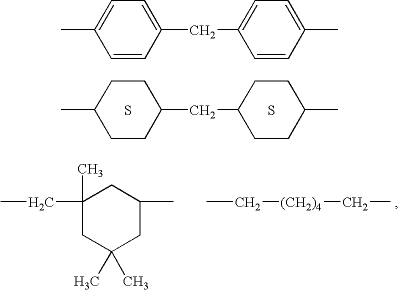

A represents the residue of a polyol, such as a) a dihydroxy polyester obtained by esterification of a dicarboxylic acid such as succinic acid, adipic acid, suberic acid, azelaic acid, sebacic acid, phthalic, isophthalic, terephthalic, tetrahydrophthalic acid, and the like, and a diol such as ethylene glycol, propylene-1,2-glycol, propylene-1,3-glycol, diethylene glycol, butane-1,4-diol, hexane-1,6-diol, octane-1,8-diol, neopentyl glycol, 2-methyl-propane-1,3-diol, nonane-1,9-diol or the various isomeric bis-hydroxymethylcyclohexanes, b) a polylactone such as polymers of ε-caprolactone and one of the above mentioned diols, c) a polycarbonate obtained, for example, by reacting one of the above-mentioned diols with diaryl carbonates or phosgene, or d) a polyether such as a polymer or copolymer of styrene oxide, propylene oxide, tetrahydrofuran, butylene oxide or epichlorohydrin,

R₂ represents the residue of a diol having a molecular weight less than about 500, such as the diols listed above for A, and

R₃ represents an alkylene, arylene or aralkylene linking group containing one or more phosphonate, carboxylate or sulfonate groups which have been neutralized with a base, such as triethylamine, sodium hydroxide, potassium hydroxide, etc, and

R₄ is optional and may represent the residue of a diamine having a molecular weight less than about 500, such as ethylene diamine, diethylene triamine, propylene diamine, butylene diamine, hexamethylene diamine, cyclohexylene diamine, phenylene diamine, tolylene diamine, xylylene diamine, 3,3′-dinitrobenzidene, 4,4′-methylenebis(2-chloroaniline), 3,3′-dichloro-4,4′-biphenyl diamine, 2,6-diaminopyridine, 4,4′-diamino diphenylmethane, and adducts of diethylene triamine with acrylate or its hydrolyzed products. These materials are preferred due to their availability and compatibility with the present invention.

The polyurethane employed in the invention preferably has a Tg between about −50° C. and 100° C. A plasticizer may also be added if desired. In a preferred embodiment of the invention, the polyurethane has a number average molecular weight of from about 5,000 to about 100,000, more preferably from 10,000 to 50,000. The anionic, water-dispersible polyurethane employed in the invention may be prepared as described in “Polyurethane Handbook”, Hanser Publishers, Munich Vienna, 1985. Polyurethanes with these properties are readily available and effective in the present invention. An example of an anionic, water-dispersible polyurethane that may be used in the inner layer of the invention is Witcobond® 232 (Witco Corporation). An example of a polyurethane for use in the overcoat layer is Witcobond® UCX 244 (Witco Corporation).

Matte particles may be added to any or all of the layers described in order to provide enhanced printer transport, resistance to ink offset, or to change the appearance of the ink receiving layer to satin or matte finish. In addition, surfactants, defoamers, or other coatability-enhancing materials may be added as required by the coating technique chosen.

Typically, dye mordants are added to ink receiving layers in order to improve water and humidity resistance. However, most mordant materials adversely affect dye light stability. Any polymeric mordant can be used in the ink recording layer of the invention provided it does not adversely affect light fade resistance. For example, there may be used a cationic polymer, e.g., a polymeric quaternary ammonium compound, or a basic polymer, such as poly(dimethylaminoethyl)-methacrylate, polyalkylenepolyamines, and products of the condensation thereof with dicyanodiamide, amine-epichlorohydrin polycondensates, lecithin and phospholipid compounds. Examples of mordants useful in the invention include vinylbenzyl trimethyl ammonium chloride/ethylene glycol dimethacrylate, vinylbenzyl trimethyl ammonium chloride/divinyl benzene, poly(diallyl dimethyl ammonium chloride), poly(2-N,N,N-trimethylammonium)ethyl methacrylate methosulfate, poly(3-N,N,N-trimethyl-ammonium)propyl methacrylate chloride, a copolymer of vinylpyrrolidinone and vinyl(N-methylimidazolium chloride, and hydroxyethyl cellulose derivitized with (3-N,N,N-trimethylammonium)propyl chloride.

Any support or substrate may be used in the recording element of the invention. The support for the ink recording element used in the invention can be any of those usually used for inkjet receivers, such as resin-coated paper, paper, polyesters, or microporous materials such as polyethylene polymer-containing material sold by PPG Industries, Inc., Pittsburgh, Pa. under the trade name of Teslin®, Tyvek® synthetic paper (DuPont Corp.), impregnated paper such as Duraform®, and QPPalyte® films (Mobil Chemical Co.) and other composite films listed in U.S. Pat. No. 5,244,861. Opaque supports include plain or calendered paper, coated paper, paper coated with protective polyolefin layers, synthetic paper, photographic paper support, melt-extrusion-coated paper, and laminated paper, such as biaxially oriented support laminates. Biaxially oriented support laminates are described in U.S. Pat. Nos. 5,853,965, 5,866,282, 5,874,205, 5,888,643, 5,888,681, 5,888,683, and 5,888,714, the disclosures of which are hereby incorporated by reference. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate, polyesters, such as poly(ethylene terephthalate), poly(ethylene naphthalate), poly(1,4-cyclohexanedimethylene terephthalate), poly(butylene terephthalate), and copolymers thereof, polyimides, polyamides, polycarbonates, poly(vinyl chloride), polystyrene, polyolefins, such as polyethylene or polypropylene, polysulfones, polyacrylates, polyetherimides, and mixtures thereof. The papers listed above include a broad range of papers, from high end papers, such as photographic paper to low end papers, such as newsprint. In particular, polyethylene-coated paper or poly(ethylene terephthalate) are preferred and are commonly used in imaging applications.

The support used in the invention may have a thickness of from about 50 to about 500 μm, preferably from about 75 to 300 μm to provide acceptable look and feel as well as effectiveness in the present invention. Antioxidants, antistatic agents, plasticizers and other known additives may be incorporated into the support, if desired.

In order to improve the adhesion of the ink recording layer to the support, the surface of the support may be subjected to a corona-discharge treatment prior to applying the ink recording layer. The adhesion of the ink recording layer to the support may also be improved by coating a subbing layer on the support. Examples of materials useful in a subbing layer include halogenated phenols and partially hydrolyzed vinyl chloride-co-vinyl acetate polymer. In order to impart mechanical durability to an ink recording element, crosslinkers, which act upon the binder discussed above, may be added in small quantities. Such an additive improves the cohesive strength of the layer. Crosslinkers such as carbodiimides, polyfunctional aziridines, aldehydes, isocyanates, epoxides, polyvalent metal cations, and the like may all be used.

To improve colorant fade, UV absorbers, radical quenchers or antioxidants may also be added to the ink recording layer as is well known in the art. Other additives include pH modifiers, adhesion promoters, rheology modifiers, surfactants, biocides, lubricants, dyes, optical brighteners, matte agents, antistatic agents, etc. In order to obtain adequate coatability, additives known to those familiar with such art such as surfactants, defoamers, alcohol and the like may be used. A common level for coating aids is 0.01 to 0.30 wt. % active coating aid based on the total solution weight. These coating aids can be nonionic, anionic, cationic or amphoteric. Specific examples are described in MCCUTCHEON's Volume 1: Emulsifiers and Detergents, 1995, North American Edition.

In another embodiment of the invention, a filled layer containing light scattering particles such as titania may be situated between a clear support material and the ink receptive multilayer described herein. Such a combination may be effectively used as a backlit material for signage applications. Yet another embodiment which yields an ink receiver with appropriate properties for backlit display applications results from selection of a partially voided or filled poly(ethylene terephthalate) film as a support material, in which the voids or fillers in the support material supply sufficient light scattering to diffuse light sources situated behind the image.

Optionally, an additional backing layer or coating may be applied to the backside of a support (i.e., the side of the support opposite the side on which the image-recording layers are coated) for the purposes of improving the machine-handling properties and curl of the recording element, controlling the friction and resistivity thereof, and the like.

Typically, the backing layer may comprise a binder and a filler. Typical fillers include amorphous and crystalline silicas, poly(methyl methacrylate), hollow sphere polystyrene beads, micro-crystalline cellulose, zinc oxide, talc, and the like. The filler loaded in the backing layer is generally less than 5 percent by weight of the binder component and the average particle size of the filler material is in the range of 5 to 30 μm. Typical binders used in the backing layer are polymers such as polyacrylates, gelatin, polymethacrylates, polystyrenes, polyacrylamides, vinyl chloride-vinyl acetate copolymers, poly(vinyl alcohol), cellulose derivatives, and the like. Additionally, an antistatic agent also can be included in the backing layer to prevent static hindrance of the recording element. Particularly suitable antistatic agents are compounds such as dodecylbenzenesulfonate sodium salt, octylsulfonate potassium salt, oligostyrenesulfonate sodium salt, laurylsulfosuccinate sodium salt, and the like. The antistatic agent may be added to the binder composition in an amount of 0.1 to 15 percent by weight, based on the weight of the binder. An image-recording layer may also be coated on the backside, if desired.

While not necessary, the hydrophilic material layers described above may also include a crosslinker. Such an additive can improve the adhesion of the ink receptive layer to the substrate as well as contribute to the cohesive strength and water resistance of the layer. Crosslinkers such as carbodiimides, polyfunctional aziridines, melamine formaldehydes, isocyanates, epoxides, and the like may be used. If a crosslinker is added, care must be taken that excessive amounts are not used as this will decrease the swellability of the layer, reducing the drying rate of the printed areas.

Coating compositions employed in the invention may be applied by any number of well known techniques, including dip-coating, wound-wire rod coating, doctor blade coating, gravure and reverse-roll coating, slide coating, bead coating, extrusion coating, curtain coating and the like. Known coating and drying methods are described in further detail in Research Disclosure no. 308119, published Dec. 1989, pages 1007 to 1008. Slide coating is preferred, in which the base layers and overcoat may be'simultaneously applied. After coating, the layers are generally dried by simple evaporation, which may be accelerated by known techniques such as convection heating. Slide coating, in which the base layers and overcoat may be simultaneously applied is preferred as cost effective as well as useful in the present invention.

Inks used to image the recording elements of the present invention are well-known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946, 4,239,543 and 4,781,758.

Although the recording elements disclosed herein have been referred to primarily as being useful for inkjet printers, they also can be used as recording media for pen plotter assemblies. Pen plotters operate by writing directly on the surface of a recording medium using a pen consisting of a bundle of capillary tubes in contact with an ink reservoir.

As used herein the phrase “recording element” is a material that may be used with an imaging support for the transfer of images to the element by techniques such as ink jet printing or thermal dye (ink) transfer. The thermal dye (ink) image-receiving layer of the receiving elements of the invention may comprise, for example, a polycarbonate, a polyurethane, a polyester, polyvinyl chloride, poly(styrene-co-acrylonitrile), poly(caprolactone) or mixtures thereof. The ink-receiving layer may be present in any amount which is effective for the intended purpose.

Ink-donor elements that are used with the ink-receiving element of the invention conventionally comprise a support having thereon an ink containing layer. Any ink can be used in the ink-donor employed in the invention provided it is transferable to the ink-receiving layer by the action of heat. Especially good results have been obtained with sublimable inks. Ink donors applicable for use in the present invention are described, e.g., in U.S. Pat. Nos. 4,916,112, 4,927,803 and 5,023,228.

As noted above, ink-donor elements are used to form an ink transfer image. Such a process comprises image-wise-heating an ink-donor element and transferring an ink image to an ink-receiving element as described above to form the ink transfer image.

In a preferred embodiment of the thermal ink transfer method of printing, an ink donor element is employed which compromises a poly-(ethylene terephthalate) support coated with sequential repeating areas of cyan, magenta, and yellow dye, and the ink transfer steps are sequentially performed for each color to obtain a three-color ink transfer image. Of course, when the process is only performed for a single color, then a monochrome ink transfer image is obtained.

A thermal ink transfer assemblage of the invention comprises (a) an ink-donor element, and (b) an ink-receiving element as described above, the ink-receiving element being in a superposed relationship with the ink-donor element so that the ink layer of the donor element is in contact with the ink image-receiving layer of the receiving element.

When a three-color image is to be obtained, the above assemblage is formed on three occasions during the time when heat is applied by the thermal printing head. After the first ink is transferred, the elements are peeled apart. A second ink-donor element (or another area of the donor element with a different ink area) is then brought in register with the ink-receiving element and the process repeated. The third color is obtained in the same manner.

The electrographic and electrophotographic processes and their individual steps have been well described in detail in many books and publications. The processes incorporate the basic steps of creating an electrostatic image, developing that image with charged, colored particles (toner), optionally transferring the resulting developed image to a secondary substrate, and fixing the image to the substrate. There are numerous variations in these processes and basic steps, the use of liquid toners in place of dry toners is simply one of those variations.

The first basic step, creation of an electrostatic image, can be accomplished by a variety of methods. In one form of the electrophotographic process of copiers uses imagewise photodischarge, through analog or digital exposure, of an uniformly charged photoconductor. The photoconductor may be a single-use system, or it may be rechargeable and reimageable, like those based on selenium or organic photoreceptors.

In an alternate electrographic process, electrostatic images are created iono-graphically. The latent image is created on dielectric (charge-holding) medium, either paper or film. Voltage is applied to selected metal styli or writing nibs from an array of styli spaced across the width of the medium, causing a dielectric breakdown of the air between the selected styli and the medium. Ions are created, which form the latent image on the medium.

Electrostatic images, however generated, are developed with oppositely charged toner particles. For development with liquid toners, the liquid developer is brought into direct contact with the electrostatic image. Usually a flowing liquid is employed, to ensure that sufficient toner particles are available for development. The field created by the electrostatic image causes the charged particles, suspended in a nonconductive liquid, to move by electrophoresis. The charge of the latent electrostatic image is thus neutralized by the oppositely charged particles. The theory and physics of electrophoretic development with liquid toners are well described in many books and publications.

If a reimageable photoreceptor or an electrographic master is used, the toned image is transferred to paper (or other substrate). The paper is charged electrostatically, with the polarity chosen to cause the toner particles to transfer to the paper. Finally, the toned image is fixed to the paper. For self-fixing toners, residual liquid is removed from the paper by air-drying or heating. Upon evaporation of the solvent these toners form a film bonded to the paper. For heat-fusible toners, thermoplastic polymers are used as part of the particle. Heating both removes residual liquid and, fixes the toner to paper.

The receiving layer or layers used in the ink recording element of the present can also contain various known additives, including matting agents such as titanium dioxide, zinc oxide, silica and polymeric beads such as crosslinked poly(methyl methacrylate) or polystyrene beads for the purposes of contributing to the non-blocking characteristics of the recording elements used in the present invention and to control the smudge resistance thereof, surfactants such as non-ionic, hydrocarbon or fluorocarbon surfactants or cationic surfactants, such as quaternary ammonium salts for the purpose of improving the aging behavior of the ink-absorbent resin or layer, promoting the absorption and drying of a subsequently applied ink thereto, enhancing the surface uniformity of the ink-receiving layer and adjusting the surface tension of the dried coating, fluorescent inks, pH controllers, antifoaming agents, lubricants, preservatives, viscosity modifiers, ink-fixing agents, water proofing agents, dispersing agents, UV-absorbing agents, mildew-proofing agents, organic or inorganic mordants, antistatic agents, anti-oxidants, optical brighteners, and the like. Such additives can be selected from known compounds or materials in accordance with the objects to be achieved.

The following examples are provided to illustrate the invention.

### EXAMPLE 1

A polyethylene resin coated paper was treated by corona discharge and coated by means of an extrusion/slide hopper with a 10% gelatin solution in water, (succinylated pigskin gelatin, Kind & Knox Gelatine Co.), and 0.6% 12 micron polystyrene beads, dry coverage of about 8.5 microns and an inner layer of 5% solution of Elvanol® 52-22 poly(vinyl alcohol) (DuPont) and a 30% dispersion of Witcobond® 232 polyurethane (Witco Corp), where the poly(vinyl alcohol) (PVA) and polyurethane dispersion (PUD) were mixed in a 77:23 ratio by weight at a dry coverage of 1.5 microns. An overcoat layer consisting of a 2% solution of Z-320 acetoactylated poly(vinyl alcohol) (Nippon Gohsei) and APG 325N (Cognis) and Surfactant 10 G (Arch Chemical) surfactants in a ratio by weight of 96.9/2.4/0.7 was coated over the gelatin and poly(vinyl alcohol)/polyurethane layers at a dry coverage of 1 micron. The coatings were dried thoroughly by forced air heat after application of the coating solutions.

### EXAMPLE 2

As in example 1 except that the overcoat layer consisted of a mixture of Z-210 acetoactylated poly(vinyl alcohol) (Nippon Gohsei) and Witcobond® UCX-244 polyurethane dispersion in a weight ratio of (75%/25%).

### EXAMPLE 3

As in example 1 except that the overcoat layer consisted of a mixture of Z-210 acetoactylated poly(vinyl alcohol) (Nippon Gohsei) and Witcobond® 253 polyurethane dispersion in a weight ratio of (75%/25%).

### EXAMPLE 4

As in example 1 except that the overcoat layer consisted of a mixture of Z-210 acetoactylated poly(vinyl alcohol) (Nippon Gohsei) and Morcryl® 132 vinyl latex (Rohm and Haas) in a weight ratio of (75%/25%).

### CONTROL EXAMPLE 1

As in example 1 except that the overcoat layer consisted of hydroxyethyl cellulose (HEC QP 300, Dow).

### CONTROL EXAMPLE 2

As in control example 1 except that the overcoat layer consisted of hydroxypropylmethyl cellulose (K100 LV, Dow).

### CONTROL EXAMPLE 3

As in control example 1 except that the overcoat layer consisted of methyl cellulose (A15 LV, Dow).

### CONTROL EXAMPLE 4

As in control example 1 except that the overcoat layer consisted of carboxymethyl cellulose (Carbose LT-30, Penn Carbose, Inc.).

### CONTROL EXAMPLE 5

As in control example 1 except that the overcoat layer consisted of a non-acetoacetylated poly(vinyl alcohol) (GH-23, Nippon Gohsei).

### CONTROL EXAMPLE 6

As in control example 1 except that the overcoat layer consisted of a poly(vinyl alcohol)/poly(ethylene oxide copolymer) (WO-320, Nippon Gohsei).

### Laminate Adhesion Test

A 2×4 in. composite black patch using cyan, magenta, yellow, and black ink was printed at 320% laydown at ambient room conditions with an Encad® 700 printer using E.I Premium Plus Inks Catalog No. 854-4553 (black), 863-0501 (cyan), 870-8414 (magenta), and 144-6681 (yellow) (Eastman Kodak Company). Specific printer settings are listed below in Table 1:

TABLE 1

| dpi | Pattern | Quality | Passes | Speed | Bidir |
|---|---|---|---|---|---|
| 600 | Stochastic | Best (photo) | 6 | 10 (Fast) | Yes |

About 2 hrs. after printing, ½″ wide, orange, Mylar® tape was placed down the side of the print target, partly covering the 320% black patch to provide an area to initiate the peel test. The samples were then laminated with GBC Octiva Low Melt Gloss laminate, 3 mil, Catalog No.3019170 using a Seal 400 Hot Roll Laminator with rolls set at 200° F., 0″ nip between the rollers, at a speed of 4 ft per minute. The samples were sandwiched between 2 laminates, the test laminate on the face of the print and Seal ThermaShield R Clear Gloss, 3 mil, Catalog No. 3226 on the back.

Using a sharp paper cutter, 1×2½ in. test strips were cut across the orange tape and the composite black patch. The laminate was peeled up from the orange tape and a 1×2½ in. leader was attached to the edge of the laminate. The leader was clamped in the upper jaw of an Instron® Model No. 1122 (Instron Corporation) and the taped portion of the sample was clamped in the lower jaw. The laminate was then peeled a distance of about ½ in. to 1 in. along the sample at a 180° angle with a crosshead constant rate of extension of 4″ per minute and a calibrated load cell with a capacity of 2 kg. A plot of peel force versus time was made and by averaging the pull force over the plateau region of the peel, an average peel force was calculated. The average peel force results are reported below in Table 2.

TABLE 2

| Example | Peel Force |
|---|---|
| Example 1 | Very Excellent |
| Example 2 | Good |
| Example 3 | Excellent |
| Example 4 | Good |
| Control 1 | Poor |
| Control 2 | Poor |
| Control 3 | Poor |
| Control 4 | Poor |
| Control 5 | Poor |
| Control 6 | Poor |

The above results show that the elements of the invention have superior laminate adhesion than the control elements.

The invention has been described in detail with particular reference to certain preferred embodiments thereof, but it will be understood that variations and modifications can be effected within the spirit and scope of the invention.

What is claimed is:

1. An ink recording element comprising a support having thereon a hydrophilic absorbing layer and an absorbing hydrophilic overcoat polymer layer comprising a derivatized poly(vinyl alcohol) having at least one hydroxyl group replaced by ether or ester groupings.

2. The ink recording element of claim 1 wherein said absorbing hydrophilic overcoat polymer layer comprises acetoacetylated poly(vinyl alcohol).

3. The ink recording element of claim 2 wherein said absorbing hydrophilic overcoat polymer layer further comprises a vinyl latex polymer.

4. The ink recording element of claim 2 wherein said acetoacetylated polyvinyl alcohol) has a degree of saponification of 80 to 100%.

5. The ink recording element of claim 2 wherein said acetoacetylated polyvinyl alcohol) has a degree of modification of 2.5 to 15 mol %.

6. The ink recording element of claim 2 wherein said acetoacetylated poly(vinyl alcohol) has a molecular weight of 15,000 to 150,000.

7. The ink recording element of claim 2 wherein said absorbing hydrophilic overcoat polymer layer comprises a polyurethane dispersion.

8. The ink recording element of claim 7 wherein the weight ratio of derivatized poly(vinyl alcohol) to polyurethane dispersion is between 50:50 and 95:5.

9. The ink recording element of claim 1 further comprising at least one hydrophilic inner layer between said hydrophilic absorbing layer and said absorbing hydrophilic overcoat polymer layer.

10. The ink recording element of claim 9 wherein said inner layer is present in a dry thickness amount of between 0.5 and 5 microns.

11. The ink recording element of claim 9 wherein said inner layer comprises a poly(vinyl alcohol).

12. The ink recording element of claim 11 wherein said inner layer further comprises latex polymer.

13. The ink recording element of claim 11 wherein said inner layer further comprises a polyurethane dispersion.

14. The ink recording element of claim 13 wherein the weight ratio of poly(vinyl alcohol) to polyurethane dispersion is between 50:50 and 95:5.

15. The ink recording element of claim 1 wherein said hydrophilic absorbing layer further comprises gelatin.

16. The ink recording element of claim 15 wherein said gelatin comprises acid processed osseine gelatin.

17. The ink recording element of claim 15 wherein said gelatin comprises pigskin gelatin.

18. The ink recording element of claim 16 wherein said gelatin comprises modified pigskin gelatin.

19. The ink recording element of claim 1 wherein said hydrophilic absorbing layer is present in a dry thickness of from 5 to 60 microns.

20. The ink recording element of claim 1 wherein said absorbing hydrophilic overcoat polymer layer is present in a dry thickness of between 0.5 and 5 microns.

21. The ink recording element of claim 1 further comprising dye mordants.

22. The ink recording element of claim 1 wherein said recording element is an inkjet recording element.

23. An ink printing method comprising providing an ink recording element comprising a support having a hydrophilic absorbing layer and an absorbing hydrophilic overcoat polymer layer comprising a derivatized poly(vinyl alcohol) having at least one hydroxyl group replaced by ether or ester groupings, and applying liquid ink droplets thereon in an image-wise manner.

24. The method of claim 23 wherein said absorbing hydrophilic overcoat polymer layer comprises acetoacetylated poly(vinyl alcohol).

25. The method of claim 24 wherein said absorbing hydrophilic overcoat polymer layer further comprises a vinyl latex polymer.

26. The method of claim 24 wherein said absorbing hydrophilic overcoat polymer layer further comprises a polyurethane dispersion.

27. The ink recording element of claim 26 wherein the weight ratio of derivatized poly(vinyl alcohol) to polyurethane dispersion is between 50:50 and 95:5.

28. The method of claim 23 wherein said ink recording element further comprises at least one hydrophilic inner layer between said hydrophilic absorbing layer and said absorbing hydrophilic overcoat polymer layer.

29. The method of claim 23 wherein said hydrophilic absorbing layer comprises gelatin.

30. The method of claim 29 wherein said gelatin comprises acid processed osseine gelatin.

31. The method of claim 23 wherein said absorbing hydrophilic overcoat polymer layer further comprises a latex polymer.

32. The method of claim 23 wherein said acetoacetylated poly(vinyl alcohol) has a degree of saponification of 80 to 100%.

33. The method of claim 23 wherein said acetoacetylated poly(vinyl alcohol) has a degree of modification of 2.5 to 15 mol %.

34. The method of claim 23 wherein said acetoacetylated poly(vinyl alcohol) has a molecular weight of 15,000 to 150,000.

35. The method of claim 23 wherein said ink recording element further comprises dye mordants.

36. The method of claim 23 wherein said recording element is an inkjet recording element.
